(19) United States
(12) Patent Application Publication
(10) Pub. No.: US 2005/0091957 A1
(43) Pub. Date: May 5, 2005

(54) Harvesting apparatus for tall-growing crops

(76) Inventors: Gregory H. Stanners, Seletar Air Base (SG); Christopher Blundell, Calgary (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/203,759

(22) PCT Filed: Feb. 13, 2001
(86) PCT No.: PCT/CA01/00173

Related U.S. Application Data
(60) Provisional application No. 60/182,183, filed on Feb. 14, 2000.

(51) Int. Cl. A01D 46/00

(52) U.S. Cl. 56/328.1

(57) ABSTRACT

The harvester provides a self-propelled or towed base (2) on which a telescoping tower (3) is mounted on a gimbal (7), allowing angular flexibility of the tower relative to the base. The tower resists swaying movement by the stabilizing effects of hydraulic cylinders (34) that are connected to electrically-operated hydraulic control valves, e.g. servo valves, controlled by a programmable logic controller or the like, which receives input from two inclinometers (5). An extendable multi-jointed boom (8) is mounted at or near the upper end of the tower. Mounted at the distal end of the boom is a cut fruit holding basket (11) and a funnel (12) with a chute (13), mounted to a common platform (4) that pivots to provide access to all sides of a tree. Collected fruit may be discharged periodically into a collection bin, for example when the platform is at least partially lowered to move the base and tower from location to location.

### TECHNICAL FIELD

This invention relates to harvesting equipment for tall-growing crops, and in particular to a machine (harvester) which can efficiently facilitate harvesting of palm fruit, for example.

Throughout the remainder of this description, all references will be to palms, but it should be clearly understood that the invention could be useful in any other application requiring rapid and efficient access to successive tall trees or plants.

Palms for palm oil production are typically grown in plantations within 20 degrees of the equator in areas of high rainfall. In addition to being the most productive edible oil crop (10 times the next most productive), it is one of the last significant food crops that today generally is not mechanically harvested. It is estimated that two billion ringit (about 500M US$) worth of palm oil is lost due to the inefficient harvesting practices currently used. Traditional manual harvesting of palm oil is extremely inefficient because of the heights to which the palm trees grow, making access to the fruit difficult and awkward, and resulting in significant waste because of unharvested fruit left behind.

The present invention will maximize the quantity of palm fruit harvested, and simplify crop maintenance.

### BACKGROUND ART

Traditionally, there are several steps involved in harvesting palm fruit. For short young palms (1-3.5 m tall), a sharp flat blade attached to the end of a steel water pipe (making a chisel with a 6-foot handle and a blade that is 6 inches wide at the end) is used to cut the fruit. To cut a fresh fruit bunch (hereinafter referred to as “FFB”), a cutter accelerates the blade into the FFB stalk with a underhanded upward motion. The weight of the water pipe provides enough inertia and stored energy to sever the stalk.

For older, taller palms (3.5-15 m tall), a sharp blade (roughly the size and shape of a hand scythe blade) attached to the end of a long (13+m) adjustable pole is used. The cutter carries the pole upright. It is physically taxing to raise and lower the pole because of its length. When the cutter identifies a ripe fruit, he maneuvers the blade around the top of the FFB stalk and cuts it with a vigorous downward pull on the pole. The fruit falls to the ground and, depending on the height, a number of fruitlets (loose fruit) will separate from the FFB upon impact. Loose fruit is by weight the most valuable part of the harvest.

An experienced cutter can harvest 50 to 133 bunches per day depending on height, terrain, season and how well the palms are pruned.

Once the fruit is cut, the next step involves the in-field collection, which is achieved by a second laborer, manually collecting and carrying the FFB to a haul road in a sling or on his shoulder. Loose fruit is generally collected with the use of a scoop (typically cut out of a plastic jug) and a bucket or fertilizer bag, or it is collected with a wheelbarrow, making the collector's work easier (but not significantly economical in the case of tall palms, as the rate of harvest is set by the cutter). The fruit is then carried to the haul road and left at a FFB pile.

The final stage involves moving the fruit from the haul road by a tractor (typically around 60 HP) pulling a trailer (typically 6 to 7 tonnes) along with several chargers (laborers equipped with spears or spikes) who travel down the roads stopping to pick up fruit at row ends, spearing the fruit with 3-foot spikes and throwing them over the side of the wagon. When the wagon is full, the tractor pulls it to a chute area where the fruit is dumped, much like the action of a dump truck. Trucks from the mill back under a chute (built on a hill with fruit dumped on top of hill) and a tractor equipped with a front-end loader pushes fruit down the chute onto the truck. This is the least efficient mechanism, as fruit is handled three times (generally causing damage each time). Also, the rate of collection is not well matched to the rate of cutting. The tall palm cutter is slow, so the collector's work rate is also slow and he is under-utilized, whereas the short palm collector is probably overworked.

There are presently several options to “mechanize” the collection of palm fruit. A “mechanical buffalo”, which is a simple 3-wheel carrier with a 400 kg payload and a dump bin, has been used in the collection of the fruit once it has been cut, as described above. To collect fruit, one or two chargers travel down the travel rows after the fruit is cut, using spikes to spear FFB and load into mechanical buffalo dump bin. When full, the load is dumped at the haul road and the rest of the evacuation process to the mill is as above. If loose fruit is collected, it is a separate operation as the FFB collection process is too fast for loose fruit collection. This process has proven to be more efficient than hand carrying by reducing the direct labor content and substituting capital.

Another option for collecting fruit is the use of a mini tractor/grabber which is a mini-tractor (25 hp) equipped with a hydraulic grabber, (a device like a small boom crane mounted on the back of the tractor) towing a scissor lift trailer. The operator drives down the palm rows using the grapple to pick up fruit in front of him, and deposits it in the trailer behind him. As with the mechanical buffalo, a separate operation is required to retrieve the loose fruit. When the trailer is full it is driven to a large over-the-road trailer (or a large bin that is power loaded onto a trailer like a North American refuse bin), that is placed in the field at a convenient location.

Commercially available aerial lift devices have been experimented with but have not been adopted by the palm oil industry. The chief drawback of these devices is that they cannot position an operator fast enough to be economically practical. Specific classes of machines and their problems are discussed below:
Articulating Boom Lifts: These devices elevate by means of long arms with rotary joints that straighten out to move an operator into the air and are exemplified by the bucket trucks one sees doing powerline work. These devices cannot be operated quickly nor can they travel over the ground quickly with an operator in them. They are basically a mass at the end of cantilevered beam and would result in unacceptable jostling of the cutter when moving between trees.
Telescoping Boom Lifts: These devices generally have heavy booms and require significant counterweight and/or hydraulic outriggers, making them prohibitively heavy and slow to operate. In addition they cannot access the back side of a palm and so must be maneuvered on the ground to a place where the fruit is accessible.
Scissors Platforms: Platforms that are elevated by a scissors mechanism are heavy and slow to raise, and cannot be positioned easily, nor practically.

Drawbacks of the prior art in generally include the following:
Lack of Trained Workers (Tall Palm). Harvesting of tall palm (12M+) is a difficult skill to acquire. Typically, cutters grow up on the plantation, and thus train over a number of years. Harvesting palm is physically demanding, which is exacerbated by the heat and humidity.
Crop Loss (Tall Palm). The height to which the palms grow, and the restricted visibility due to poor thinning, make it difficult for a cutter to identify ripe fruit, so it is often missed. Palms are not of uniform height so it is often necessary to adjust the length of the harvesting pole. Because the workers are paid on a piecework basis, the energy and time required to harvest the occasional tall or short palm is not worth the money, and these fruits are bypassed in favor of easier fruit. Furthermore, fruitlets which fall off the FFB when it hits the ground all are not all recovered.
Fruit Damage. The more the fruit is handled, the more it is damaged. When the FFB falls from the tree the fruit is bruised, which starts a chemical reaction that reduces the value of the crop. The longer it takes to be processed, the greater the decline in value. At every handling this situation is aggravated. The traditional method handles the fruit five times (drop from tree, drop at road, load into wagon, drop at chute, load into truck), and even the most advanced methods involve at least three handlings.

Access in Wet Weather. Existing harvest collection methods depend on vehicle systems that do not have a high degree of mobility over soft ground. This makes harvesting problematic during monsoon season, and generally over any ground that is marshy.

To be commercially viable, a machine ideally should achieve most or all of the following objectives, on average at least once a minute:
1. Travel 27 m between trees
2. Move the cutter from his position while traveling to a fruit that is 15 m+high.
3. Position the cutter directly below the fruit to be harvested, anywhere around the circumference of the tree
4. Allow the cutter to cut the fruit easily
5. Convey the cut fruit to a bin (dump box)
6. Return the cutter to the travel position and begin moving to the next tree.

### DISCLOSURE OF INVENTION

To address the above drawbacks of the prior art, the invention provides an integrated harvesting machine having a self-propelled, aerial lift device with an elevating dump box that moves from the palm to a roadside container for transport to the mill.

The invention includes a towed or self-propelled vehicle with a vertically telescoping tower that has a man-carrying platform attached to the end of a multi-jointed boom. The configuration enables positioning a cutter in close proximity to the fruit for effective harvesting. Attached to the platform is a flexible, extendable funnel arrangement that terminates above an elevating dump box.

The invention allows a trained operator to come into close proximity to the crown of the palm and to quickly identify the fruit to be cut and maneuver a tool to a position to cut that fruit so that it falls into a collection means, which can be periodically discharged into a dump box. Then dump box, when full, is transported to and dumped into a container (truck) that can be moved to the mill quickly and efficiently over a variety of ground conditions with a minimum of damage.

Use of the invention will very significantly reduce the direct harvesting labor requirements. Furthermore, since the level of manual dexterity required to operate the machine is modest, operators can be trained in less time than for hand cutting. More significantly, the physical labor is significantly reduced, making the job attractive to a larger number of people. Elimination of labor issues will minimize crop losses due to scarcity of labor. Other advantages of this invention include making identification and harvesting significantly easier, thus avoiding missed fruits. The height of the fruit is not an issue for the cutter because of the ease with which one can move up and down.

Elimination of hand carrying reduces the density of haul roads required and increases the amount of land available for cultivation. Circles under the trees that were needed to retrieve loose fruit, and had to be maintained with traditional harvesting, are no longer required since there is no loose fruit to retrieve. The invention also will facilitate thinning of palms at the time of harvest, with minimum incremental effort. Harvesting can be accomplished in wet weather because the off-road capabilities of the vehicle will greatly surpass that of tractors towing trailers, allowing evacuation even during monsoon season.

### BRIEF DESCRIPTION OF DRAWINGS

The invention will now be described in greater detail, with reference to the accompanying drawings of preferred and alternative embodiments as examples, listed as follows:

FIG. 1 is a perspective overview of the harvester, showing the tower extended and the platform positioned at a palm for harvesting;

FIG. 2 is a view of the harvester with its tower retracted;

FIG. 3 is a view of the extended boom and the platform showing the person-carrying basket and the funnel;

FIG. 4 is a view of the extended boom and the platform showing the basket and the funnel;

FIG. 5 is a view of the extended boom and the platform showing the basket and the funnel;

FIG. 6 is a view of the extended boom and the platform showing the basket and the funnel;

FIG. 7 is a side view of the carrier showing the extended tower and the extended boom, with the funnel emptying into the dump box;

FIG. 8 is a side view of the carrier showing elevation of the dump box;

FIG. 9 is a front view of the carrier with the extended tower and boom;

FIG. 10 is a top view of the carrier, showing only the frame structure and the base for the tower with mounted tower;

FIG. 11 is a top view of the platform held by the boom, adjacent a palm tree;

FIG. 12 is a top view of the platform held by the boom, adjacent a palm tree;

FIG. 13 is a top view of the platform held by the boom, adjacent a palm tree;

FIG. 14 is a top view of the platform held by the boom, adjacent a palm tree;

FIG. 15A is an end view of the boom holding and pivot structure;

FIG. 15B is a side view of the boom holding and pivot structure;

FIG. 16 is a top view of the hydraulic cylinders mounted to the telescoping tower and the base of the carrier;

FIG. 17 is a side view of the gimbal-mounted telescoping tower;

FIG. 18 is a partially sectioned side view of the tower, showing a pulley system for raising and lowering the tower and the support wheels of the tower segments;

FIG. 19 is a partially sectioned top view of the boom, showing the support wheels of the tower segments;

FIG. 20 is a view of the tower in position for the funnel emptying into the dump box;

FIG. 21 is a view of the elevated dump box during discharge from the dump box to a transport vehicle;

FIG. 22 is a view of the boom and the platform moving about the circumference of the palm tree; and

FIG. 23 is a view of the boom and the platform moving about the circumference of the palm tree.

### BEST MODE FOR CARRYING OUT THE INVENTION

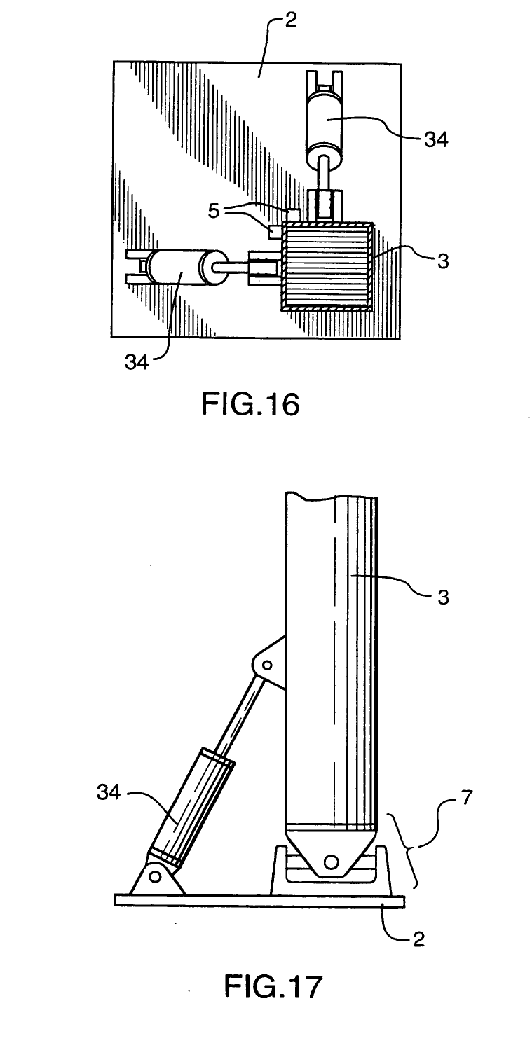

The invention includes a vehicle or carrier 1, either self-propelled or towed, providing a base 2 on which a telescoping tower 3 (vertical boom) is mounted on a gimbal 7, allowing angular flexibility of the tower relative to the base. The tower 3 resists swaying movement by the stabilizing effects of hydraulic cylinders 34 that are connected to electrically-operated hydraulic control valves, e.g. servo valves (not shown). A programmable logic controller (PLC) or a microprocessor which receives input from two inclinometers 5 controls these valves (see FIG. 16). This mechanism allows the tower to remain vertical while the vehicle is moving over sloped or undulating ground. This feature of the invention is important as it allows the vehicle to move quickly between the trees while maintaining the comfort and safety of the cutter who is positioned on a platform 4 at the top of the tower, and maintains the overall stability of the vehicle.

Other means of maintaining a level platform or base when moving over uneven or inclined terrain are known, and could be readily adapted to the present invention. The invention is not necessarily limited to the specific leveling means just described.

The tower 3 preferably is a closed-section box structure that is stiff compared to open-sections characteristic of many other telescoping mechanisms, thus reducing the whip the operator might otherwise feel while moving at such a height. It could also be tubular, i.e. circular in cross-section. The tower is mounted to one side of the center of the carrier 1, to act as a counterweight to offset the overturning moment that would be caused by the outward movement of the operator while harvesting.

An extendable multi-jointed boom 8 (horizontal boom) is mounted at or near the upper end of the tower 3. The boom extension could be any linear actuating device, for example in this case a fluid power cylinder 9. The extension of the boom is continually monitored by a linear positioning feedback device. The boom 8 is slidingly held in a boom holder 22 and the cylinder 9 is held in a cylinder holder 23, which is fixed to the boom holder. The cylinder has a piston rod 24, which is fixed to the boom 8 at a piston rod attachment 25.

The boom rotating device could be any device or linkage that creates an orbital motion, in this case a fluid power rotary actuator 10. The rotary position of the boom is continuously monitored by a rotary position feedback device.

Mounted at the distal end of the boom is a cut fruit holding basket 11 and a funnel 12 with a chute 13, mounted to a common platform 4 that pivots. The platform rotating device could be any device or linkage that creates orbital motion, in this case, a fluid power rotary actuator 15. The rotary position of the platform can be continuously monitored by a rotary position feedback device. Also mounted on the platform 4 is a cutting operator holding structure 6, with a protective guardrail. The basket 11 has vertically indented portion 11′ arranged on opposite ends of the basket, to allow fitting one indentation around a part of a trunk of a palm tree 14.

The pivot point of the fluid power rotary actuator 15 is arranged at some distance from the center of the funnel 12 so that a combination of the above-mentioned positioning feedback devices, and a suitable algorithm to control the power of the actuators, will enable the funnel to be moved in a circular path around the palm 14, permitting 360° access to the palm fruit during a single set-up, using a single control device. Otherwise three controls for the rotary actuators 10 and 15 and boom extension 24 would have to be manipulated in a controlled fashion, which would be slow and which would require too much skill to be economical.

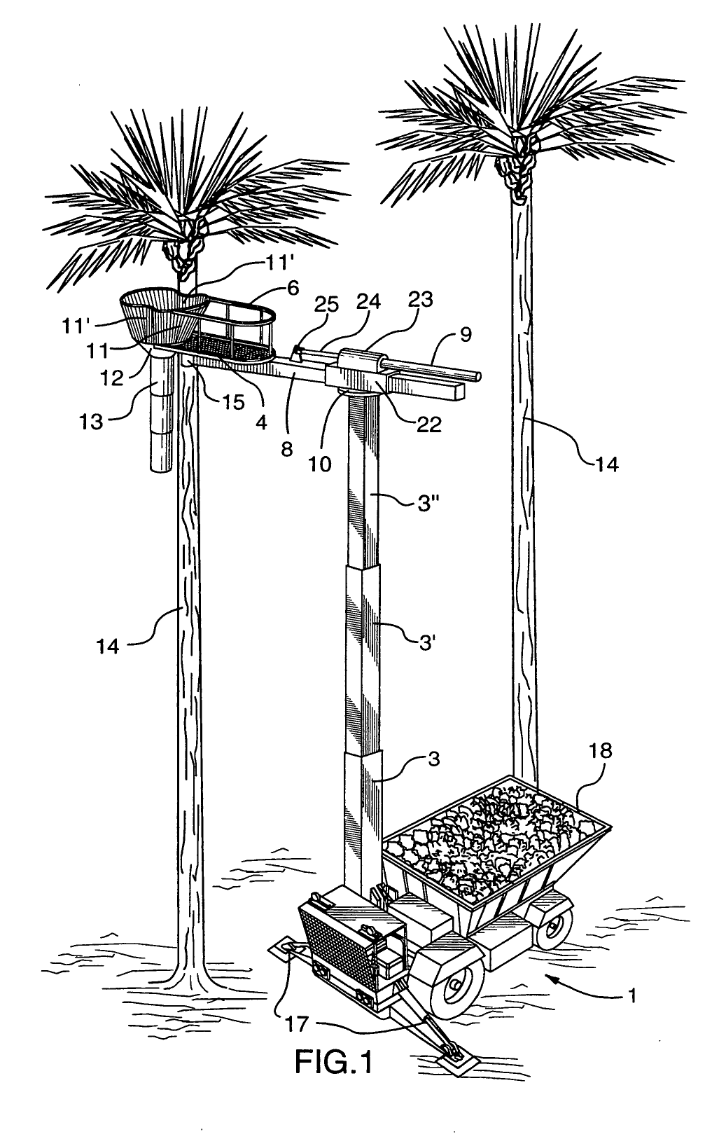

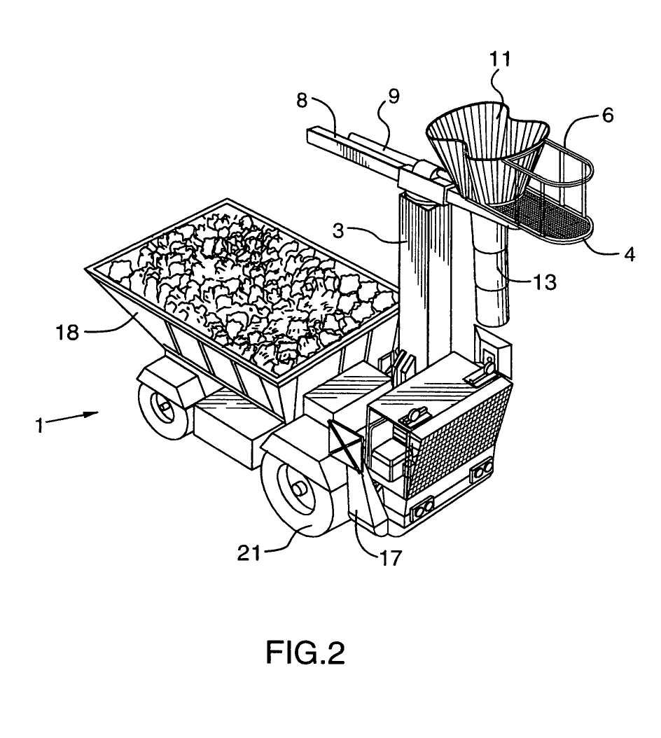

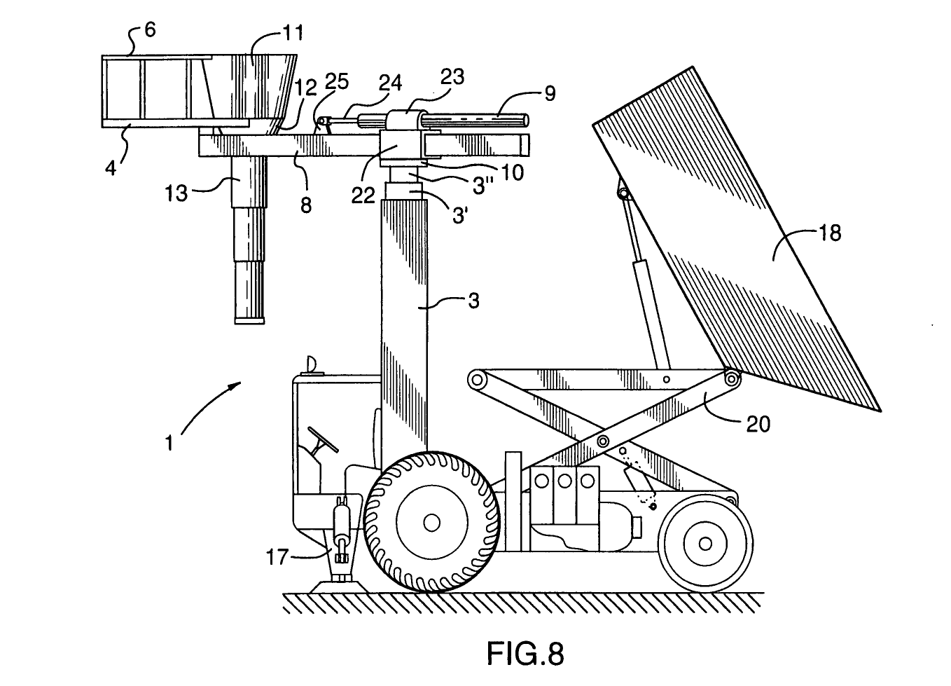

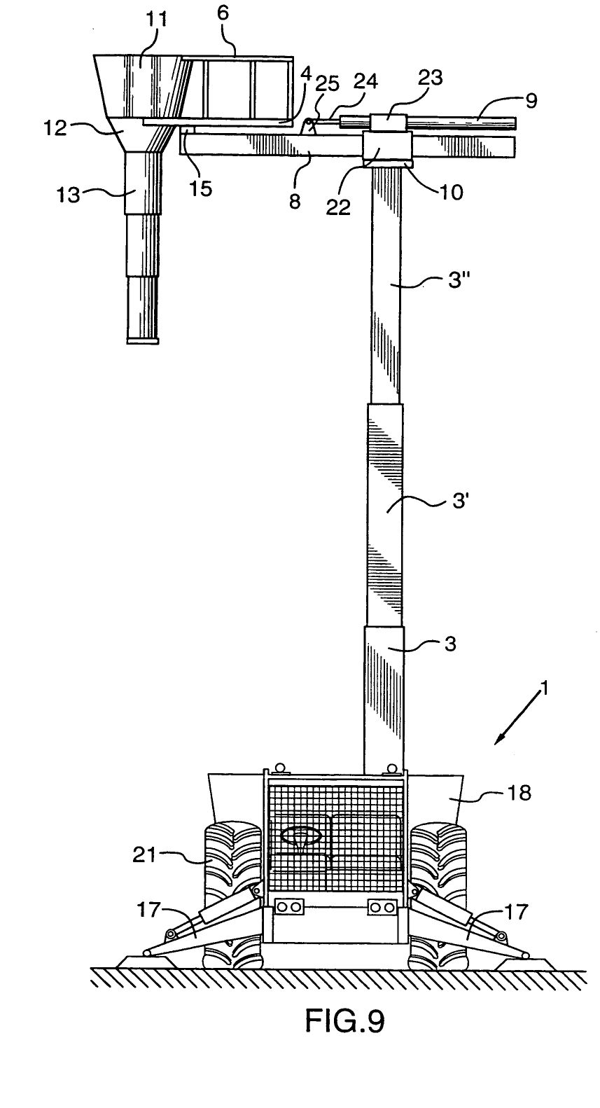

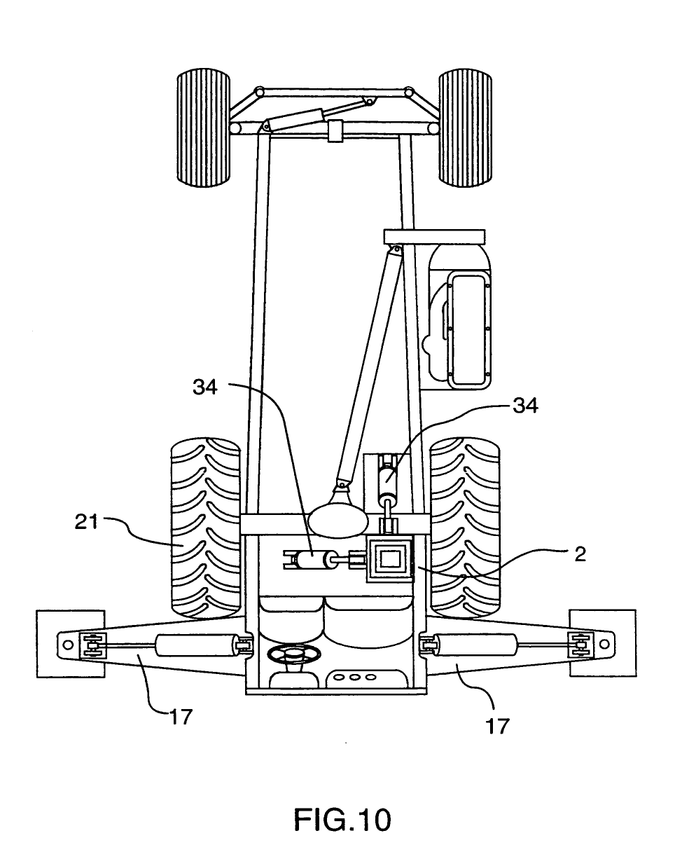

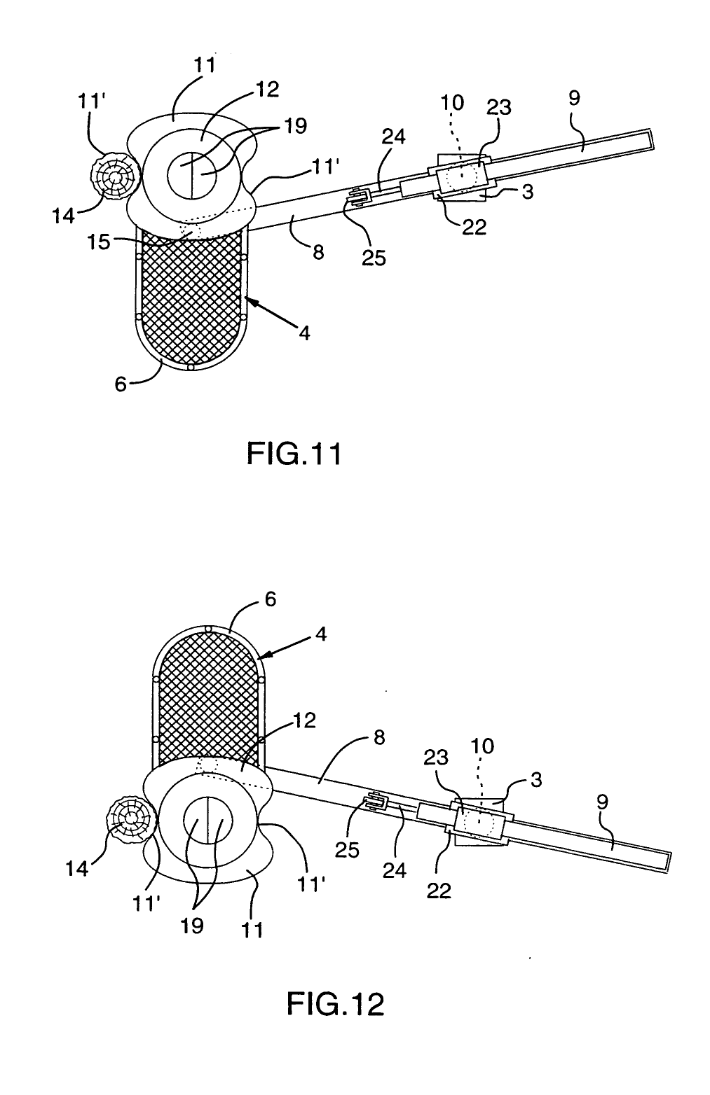

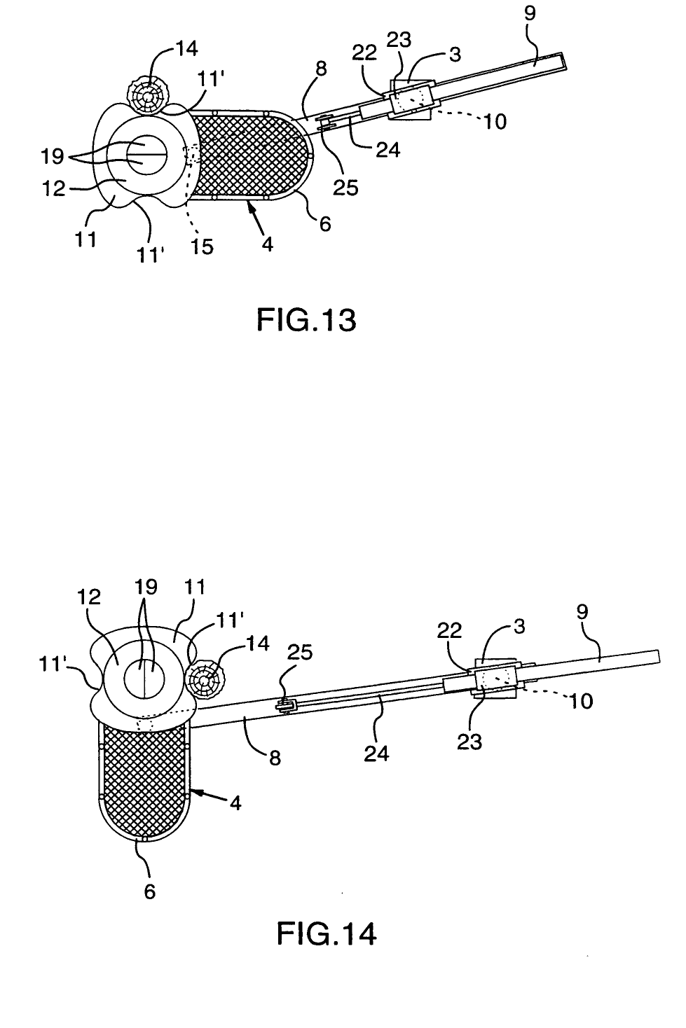

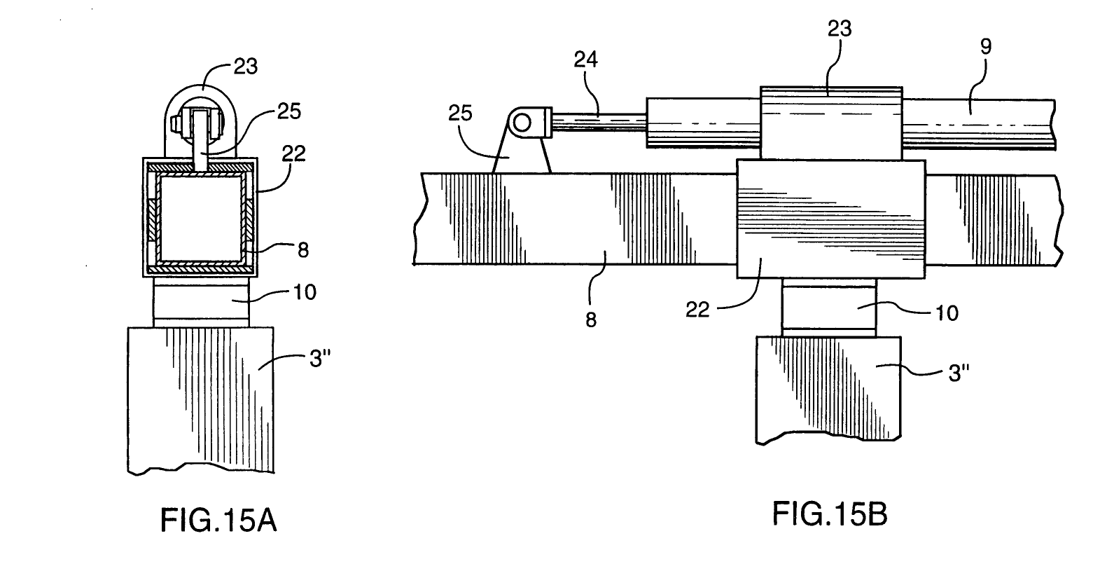

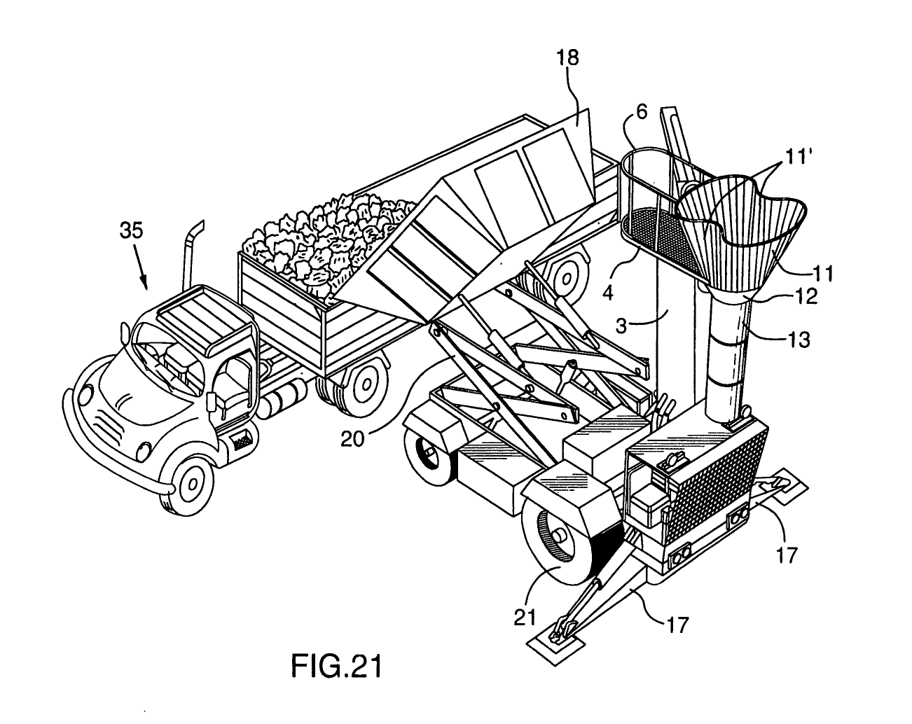

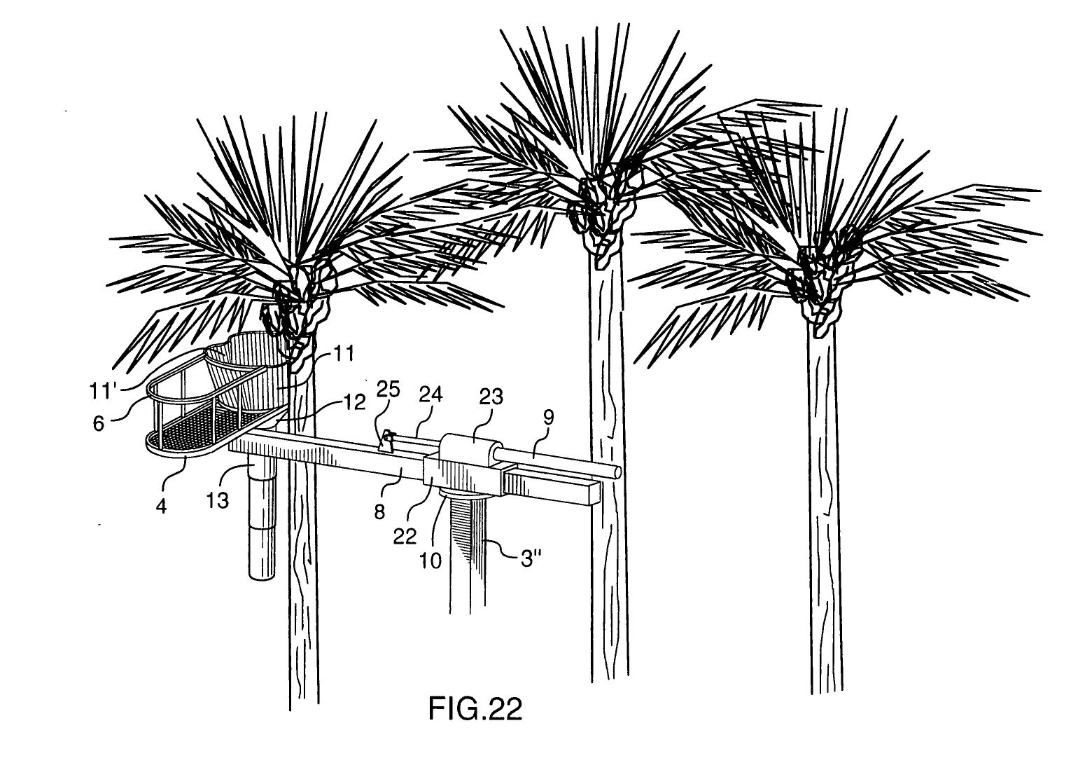

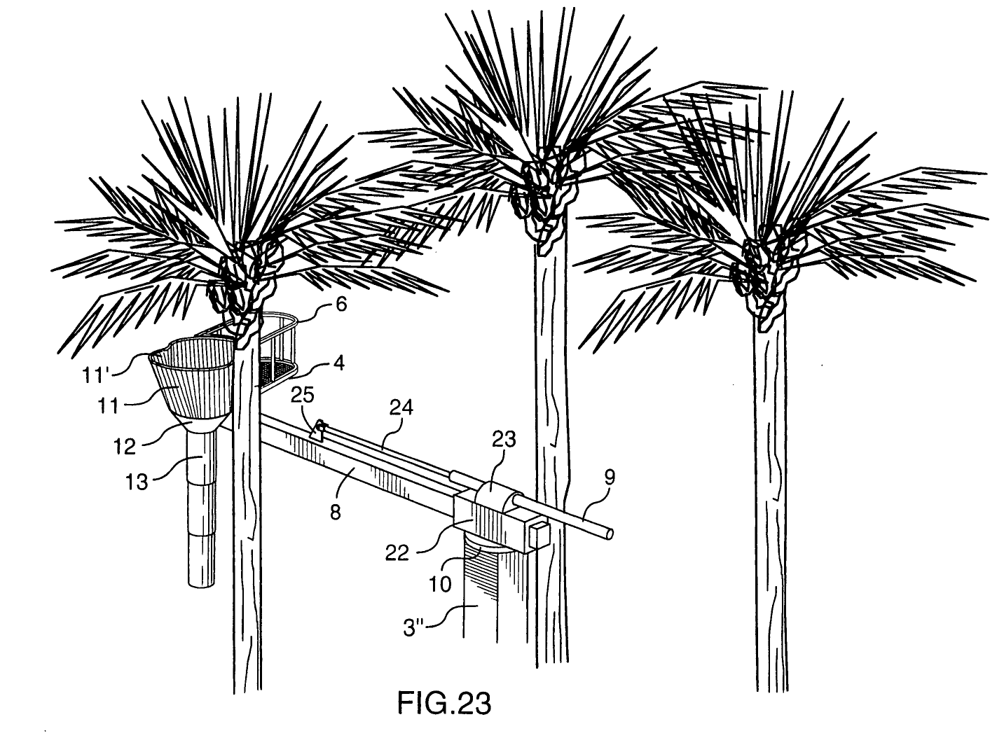

FIG. 1 shows the overall machine, having a telescoping vertical tower 3 extending upwardly from the vehicle 1, offset away from the working side for built-in counterbalancing. The tower 3 has a plurality of telescoping members. Shown are a first member 3′ and a second member 3″. Preferably two outriggers 17 are also provided, for lateral stability, preferably mounted on each side of a forward portion of the carrier vehicle 1. They can be raised and lowered quickly when moving from location to location. Extending horizontally outwardly from the top of the tower is the boom 8 with its platform 4 and basket 11 at a distal end for the worker, and a funnel 12 connected to a chute 13 which can be discharged periodically to a collection bin 18. The funnel/chute assembly has a trap door 19 or the like, which the operator can actuate to dump the collected fruit while traveling between palms. For better stability, the platform typically will be lowered to about half of its maximum height when traveling between palms, and will be positioned over the dump box (collection bin) 18, so that is when the operator would actuate the trap door arrangement. The collection bin preferably is mounted on a scissor lift 20 as shown in FIG. 8, so that it can be raised and lowered as desired, for example for dumping as in FIG. 8 or FIG. 21. In FIG. 21, a transport truck 35 is shown, as an example of transport vehicles used. Other examples are railway cars and boats/ships/barges.

Preferably, on command from the operator, the funnel 12 will automatically locate at a fixed height and position above the bin 18, for gravity discharge upon release of the trap door 19, which may also be automatic. Once automatically located, the operator preferably can override the automatic position and relocate for discharge elsewhere if desired. Preferably, the PLC or computer is programmed so that the funnel can be returned automatically (if selected by the operator) to its previous palm head location directly via the shortest route.

Preferably, the palm head starting position is predetermined as vertically above the front right vehicle tire 21 which is adjacent to the palm, and the default height is preset according to the field being worked.

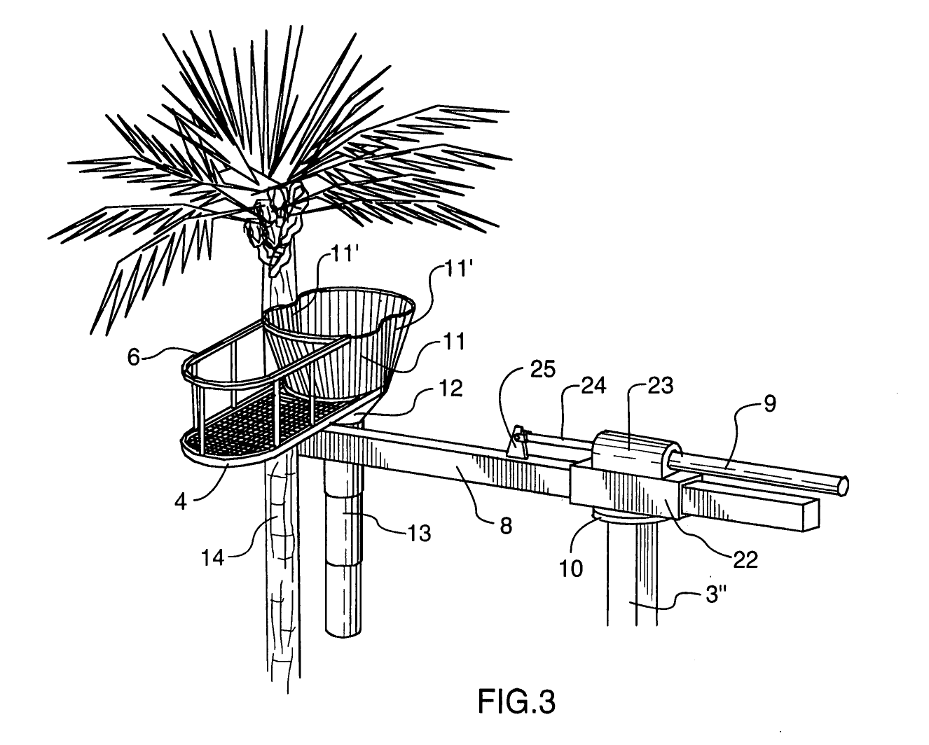

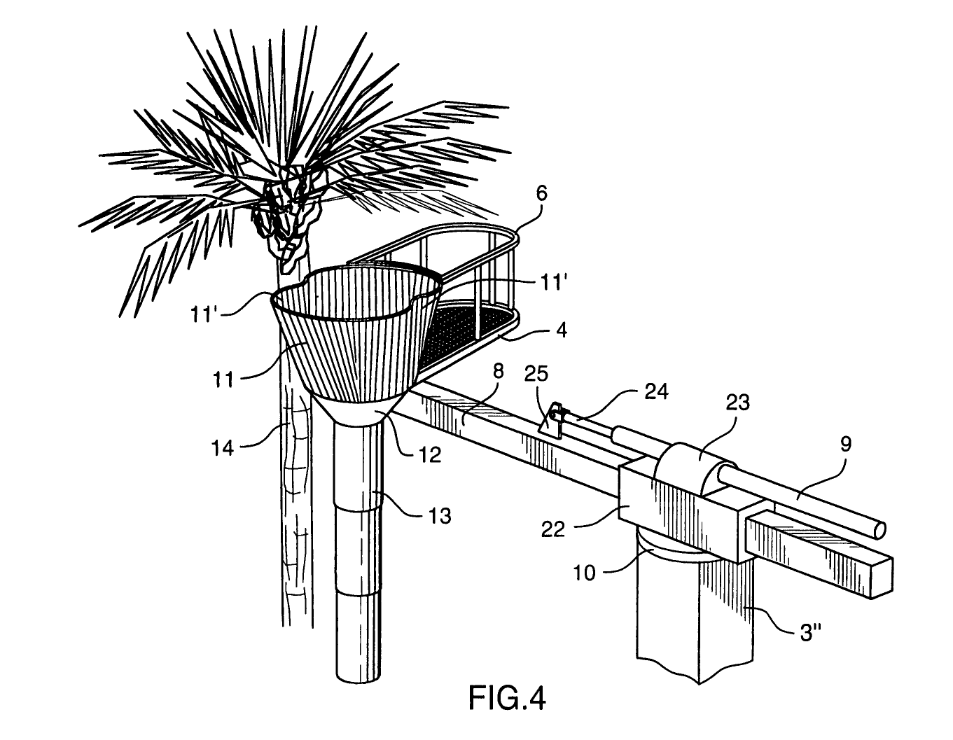

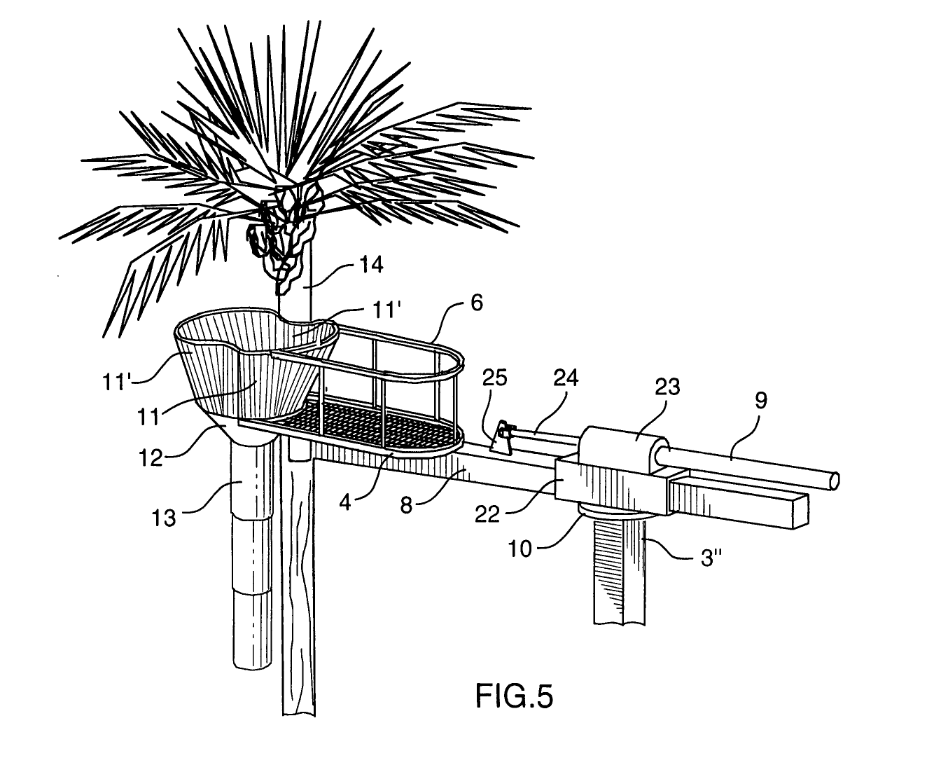

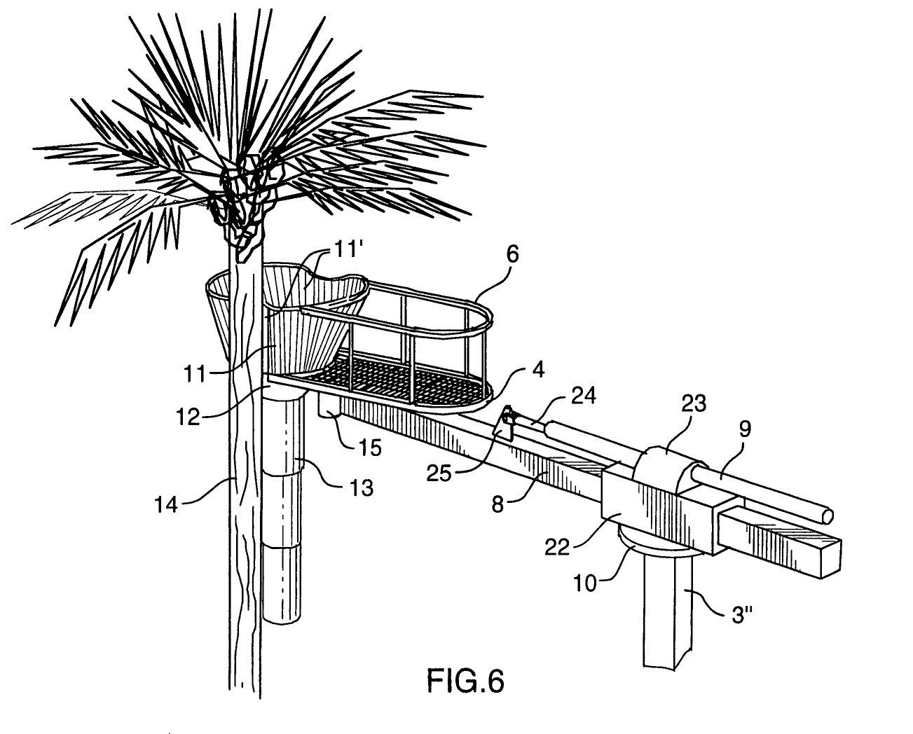

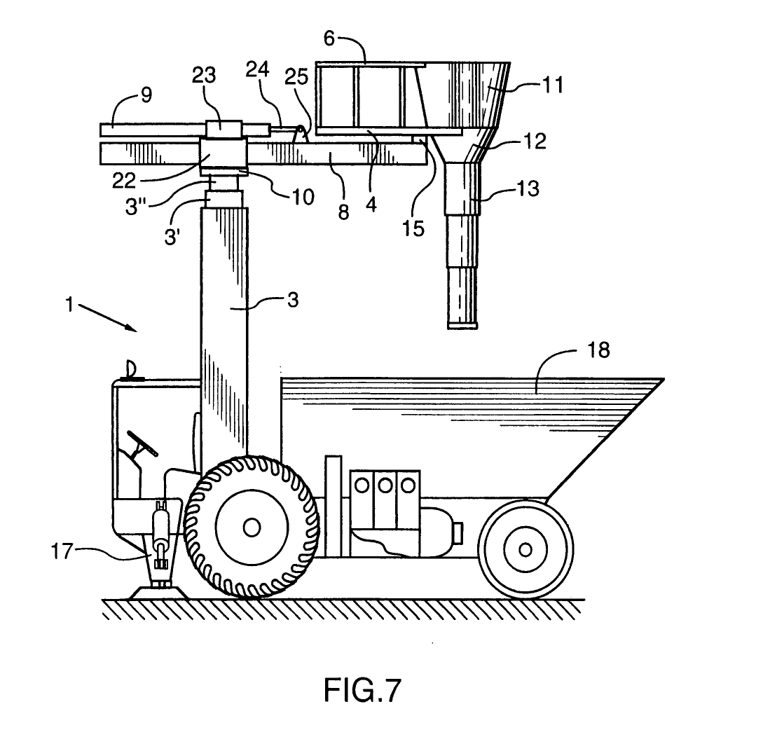

As can be seen from FIGS. 3 and 4, the platform 4 and funnel 12 and chute 13 assembly swings around at the end of the boom, to allow opposite sides of the palm to be harvested. The pivot point is arranged at some distance from the center of the funnel so that a combination of the four degrees of freedom of motion (up-down, in-out, left-right, and pivot) will allow the worker and funnel to be positioned at any desired location around the circumference of the palm.

Preferably, the machine's controls will incorporate a computer or PLC programmed to coordinate the motion of the platform to create a circular path around the tree, based on input from a single control like a rheostat rather than manually-coordinated control of three actuating devices that would normally be required to produce the same motion. The importance of this is that manually controlling this action is very difficult and thus slow, requiring a long training curve, whereas automatic operation with one control can be fast and makes the operation more economical.

In general, the worker on the platform 4 will have some controls, and the vehicle driver will have some controls. If desired, the controls could be entirely duplicated, so that either person could control any function.

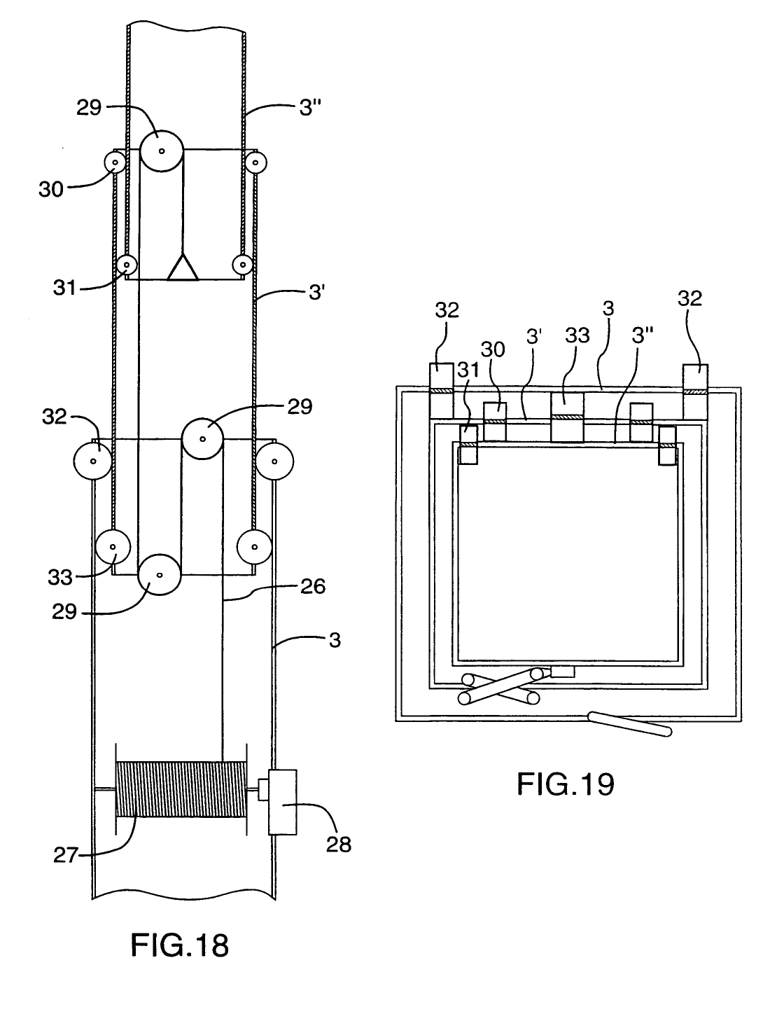

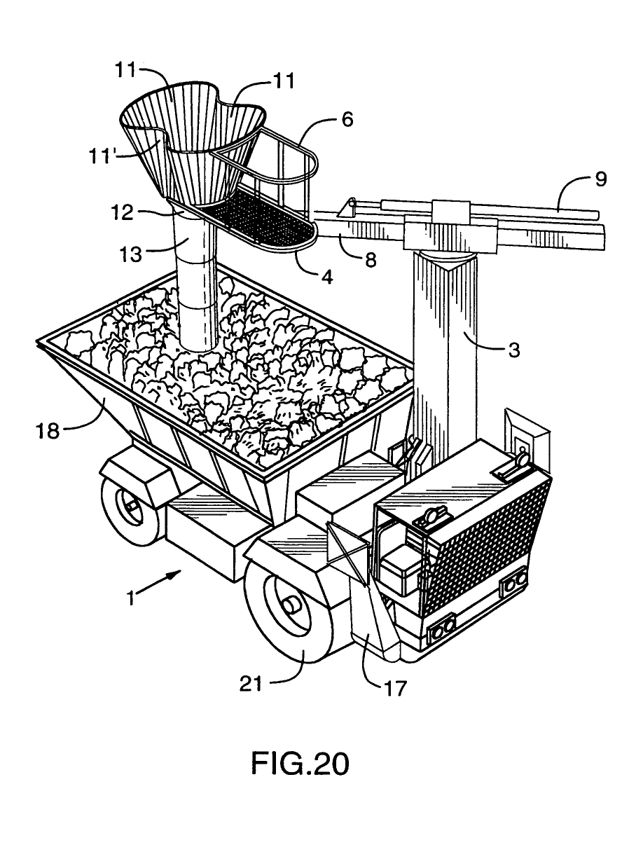

A preferred mechanism for raising and lowering the tower 3, with its first member 3′ and second member 3″, is shown in FIGS. 18 and 19. The tower first support wheels 32 and the first segment has second support wheels 33, to guide the first segment during its movement relative the tower. The first segment 3′ further has third support wheels 30 and the second segment 3″ has fourth support wheels 31, to guide the second segment during its movement relative the first segment. The raising and lowering movement is provided by a rope 26, which runs over pulleys 29 fixedly arranged inside the first segment and the second segment. The rope is coiled and uncoiled onto a drum 27 by a remotely operated and reversible winding motor 28. Other propulsion systems may be used to provide the movement for the first and second segments, for instance hydraulic cylinders preferably located inside the tower and the first and second segments.

### INDUSTRIAL APPLICABILITY

The invention provides for more effective harvesting of tall-growing crops.

1. A harvesting machine, characterized by:
a transportable base (2), having a gimbal-mounted telescoping tower (3) extendable generally vertically upwardly therefrom;
means (5, 34) for maintaining said tower in a generally vertical orientation regardless of the orientation of said base;
an extendable boom (8) mounted at an upper portion of said tower, extendable generally horizontally away from said tower;
a work platform (4) mounted at a distal end of said boom; and
collection means (11) on said work platform for receiving harvested crop.

2. A machine as recited in claim 1, wherein said work platform is pivotally mounted, for pivoting about a generally vertical axis.

3. A machine as recited in claim 1, wherein said means for maintaining said tower in a generally vertical orientation comprises actuators (34) arranged between said base and said tower, inclinometers (5) on either or both of said base and said tower, and automatic control means for actuating said actuators in response to inputs from said inclinometers.

4. A machine as recited in claim 1, wherein said tower is mounted on a side of the base opposite the side from which the boom extends, for inherent counterbalancing.

5. A machine as recited in claim 1, wherein said collection means comprises a basket (11) having a funnel (12) connected to a chute (13), and wherein said base carries a collection bin (18) into which said chute may be periodically discharged.

6. A machine as recited in claim 1, wherein said base is carried by a self-propelled vehicle (1).

7. A method of harvesting a tall-growing crop using a harvesting machine as in claim 1, said method characterized by operating said harvesting machine to elevate said platform to the general height of the product to be harvested, manually collecting said product and depositing it in said collection means, lowering said platform at least partially when sufficient product has been collected at one location, to a height where product may be discharged from said collection means, moving said base to another location, and again elevating said platform to repeat the preceding steps.

8. A method as recited in claim 7, using a harvesting machine as in claim 5, wherein said product is discharged from said basket via said funnel and chute, into a collection bin.
